(19) United States
(12) Patent Application Publication
(10) Pub. No.: US 2022/0238132 A1
(43) Pub. Date: Jul. 28, 2022

(54) Face Mask with Integrated Communication System

(71) Applicants: Anna Smith, Hamilton, MS (US); James Frazier, Sturgis, MS (US)

(72) Inventors: Anna Smith, Hamilton, MS (US); James Frazier, Sturgis, MS (US)

(21) Appl. No.: 17/218,244

(22) Filed: Mar. 31, 2021

Related U.S. Application Data
(60) Provisional application No. 63/142,958, filed on Jan. 28, 2021.

(51) Int. Cl. G10L 21/0364; H04R 3/00; A41D 13/11; H04R 1/02; G06F 3/16; H04R 1/08

(52) U.S. Cl. CPC G10L 21/0364; H04R 3/00; A41D 13/11; H04R 2201/028; G06F 3/165; H04R 1/08; H04R 2420/07; H04R 1/028

(57) ABSTRACT

This present invention relates to a face mask with an integrated communication system that ensures the safety of the wearer while allowing the same to effectively communicate with others while wearing the face mask. The face mask features a voice modulator having a microphone and a speaker removably attached to the mask body. The wearer can easily speak into the microphone and the voice of the wearer is captured by the microphone and is clearly projected and modulated by the speaker. Additionally, the wearer may adjust the volume of the speaker as per the needs and requirements of the wearer.

### CROSS-REFERENCE TO RELATED APPLICATION

The present application claims priority to, and the benefit of, U.S. Provisional Application No. 63/142,958, which was filed on Jan. 28, 2021 and is incorporated herein by reference in its entirety.

### FIELD OF THE INVENTION

The present invention relates generally to the field of protective face masks. More specifically, the present invention relates to an improved face mask that enables teachers, presenters, and other individuals to project and amplify their voice clearly while maintaining safety by wearing a protective face mask. The mask of the present invention features an attached microphone and a speaker or amplifier, to ensure the mask wearer is properly heard while speaking. The components such as microphone and speaker are detachable and therefore enable the user to wash and reuse the mask as needed. More specifically, the components can be attached to the mask body by means of a snap, button, magnets, hook and loop, or similar fastener. Other mechanisms to removably attach the components to the mask body can also be used. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, many people take measures to prevent themselves from the transmission of infectious diseases. Various different kinds of germs, viruses, bacteria and other harmful pathogens are present in the environment, which when inhaled by an individual can cause the individual to contract an infectious disease. In times of a pandemic, which is an epidemic of an infectious disease which spreads across a large region, for instance multiple continents or worldwide, and affects a substantial number of individuals, it is extremely difficult to attain protection against the transmission of the disease. Further, pandemics involving COVID-19 and other infectious diseases can be dangerous for the health of the individuals that contract the same and may, in some instances, lead to the death of the individual. During the COVID-19 pandemic, face masks, such as surgical masks and cloth masks, have been employed as a public and personal health control measure against the spread of SARS-CoV-2. In both community and healthcare settings, their use is intended as source control to limit transmission of the virus and personal protection to prevent infection. Their function for source control is emphasized in community settings.

To prevent the spread of diseases and pandemics, various solutions have been proposed and guidelines have been laid down by the healthcare community. For example, individuals are advised to maintain personal hygiene, wash their hands frequently, wear protective face masks, maintain social distancing and more, wherein wearing a protective face mask is a mandatory measure which is to be followed to prevent the spread of infectious diseases. The protective face mask usually covers the oral and nasal passageways of the wearer as well as his or her cheeks and chin area, and is meant to prevent or at least minimize the transmission of germs, bacteria, or other harmful pathogens from surroundings to the individual. Conversely, face masks also prevent or at least minimize the transmission of germs, bacteria, or other harmful pathogens from the individual to his or her surroundings.

Unfortunately, while a protective face mask forms a barrier to the transmission of germs, etc., the face mask body also acts as a barrier for the voice of the wearer as he or she is speaking and tends to muffle the sound. More specifically, the intensity and clarity of the voice of the wearer diminishes when the wearer speaks while wearing the protective face mask. Accordingly, the wearer may need to speak louder and slower, or use his or her hands and other body language to communicate with other people, and some individuals may experience difficulty altogether while speaking and wearing a mask at the same time. Others may be unable to hear the person speaking which can be especially problematic for public speakers, such as teachers, trainers, doctors, working professionals, etc., who are forced to wear a face mask in public places such as schools, hospitals, offices and the like.

Additionally, most protective face masks prevent the voice of the wearer from being properly projected. Public speakers, such as teachers, trainers, or the like, may have to continuously speak loudly or even shout while speaking to others in a public place so as to effectively communicate. In such scenarios, the speaker may quickly become exhausted. Additionally, in such situations, the speaker may be inclined to remove the protective face mask out of frustration so as to more easily communicate with others, which could put both the speaker and his or her audience at risk for the transmission of infection diseases.

Therefore, there exists a long felt need in the art for a protective face mask that prevents or minimizes the transmission of harmful pathogens and the spread of infectious diseases. There is also a long felt need in the art for a protective face mask with an integrated communication system that enables an individual to be easily and clearly heard by others while wearing the protective mask. Additionally, there is a long felt need in the art for a face mask with an integrated communication system that enables a public speaker to more conveniently communicate with others while wearing the mask in a public place, and while also maintaining safety precautions against the transmission of germs, etc. Further, there is a long felt need in the art for a face mask with an integrated communication system that eliminates the need for the wearer to speak loudly, slowly and/or communicate through other actions to effectively communicate with others, and that enables teachers, trainers, presenters, professionals and others to project and/or amplify their voices. Finally, there is a long felt need in the art for a protective face mask with an integrated and removable communication system that is relatively inexpensive to manufacture, reusable, and both safe and easy to use.

The subject matter disclosed and claimed herein, in one embodiment thereof, comprises a personal protective face mask with a removably integrated communication system. More specifically, the communication system comprises a microphone and speaker unit designed to project the wearer's voice while also maintaining safety via the protective face mask. The protective face mask can comprise a left curved outer surface, a right curved outer surface, a top edge and a bottom edge, wherein the outer surfaces are designed to fit over the wearer's oral and nasal passageways. Further, a snap button cap positioned on the left curved outer surface is designed to receive the microphone and speaker unit, wherein the microphone and speaker unit has a socket, and the snap button cap and the socket matingly engage one another to removably attach the microphone and speaker unit to the face mask. The wearer then speaks into the microphone and is heard via a projected and/or amplified sound by his or her audience.

In this manner, the novel face mask with integrated communication system of the present invention accomplishes all of the forgoing objectives, and provides a relatively safe, easy and convenient solution to ensure that the mask wearer is easily heard while communicating with others. The face mask with integrated communication system of the present invention is also user friendly, inasmuch as it does not require the user to take off the mask while speaking to others, and ensures that the user is properly heard by others without having to strain his or her voice. Additionally, because electrical components of the communication system are easily removable from the face mask portion, the novel face mask can be easily cleaned and reused.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a personal protective face mask with a removably attached microphone and speaker unit that is designed to project and/or amplify the wearer's voice while maintaining safety via the wearing of the protective face mask portion. The face mask preferably comprises a left curved outer surface, a right curved outer surface, a top edge and a bottom edge, wherein the outer surface is designed to fit over the wearer's oral and nasal passageways. The face mask also comprises a snap button cap positioned in a select one of the left or right curved outer surfaces, wherein the snap button cap is designed to receive the microphone and speaker unit. More specifically, the microphone and speaker unit further comprises a socket that matingly engages the snap button cap to attach the microphone and speaker unit to the face mask portion. The wearer then speaks into the microphone and the sound is amplified through the speaker in a clear and concise manner so that it can easily be heard and understood by the wearer's audience.

In a further embodiment of the present invention, a reusable personal protective face mask having a removably integrated communication system is disclosed. The mask comprises a face panel having a left curved outer surface, a right curved outer surface, a pair of adjustable ear loops to engage the ears of the mask wearer (or an adjustable head strap), a snap fastener sewn or permanently affixed to at least one of the left or right curved outer surfaces, and a separate electronic unit configured to attach to the snap fastener, wherein the electronic unit includes a microphone, speaker, battery, and control button to control the unit including, without limitation, the speaker and the microphone. The microphone takes the sound uttered by the wearer of the face mask and the speaker projects and/or amplifies the sound when the face mask is worn by the wearer with the electronic unit attached to the face mask. It is to be appreciated that the microphone transforms the air-pressure waves of sound and changes them into electric currents used in recording or transmitting sound.

In yet a further embodiment of the present invention, a protective face mask equipped with a speaker and a microphone is disclosed. The face mask portion is constructed of cloth or fibrous materials and is configured to cover both the oral and nasal passageways of the wearer from harmful pathogens, particulates and the like. The outer surface of the face mask can have, in one exemplary embodiment, a magnetic fastener sewn therein to magnetically and removably fasten a companion electronic unit thereto. The electronic unit includes a microphone, speaker, battery, control button, amplifier and a wireless communication (e.g., Bluetooth) module. The microphone can be positioned near the mouth of the wearer when the electronic unit is attached to the magnetic fastener. More specifically, the electronic unit also has a magnetic fastener of opposite polarity to the magnetic fastener present on the face mask.

In still a further embodiment of the present invention, a method of using a reusable face mask with removably attached speaker and microphone unit is disclosed. The method can comprise the steps of: (a) wearing a face mask with attached speaker and microphone for protection from pathogens while (b) projecting and/or amplifying the wearer's voice, (c) detaching the microphone and speaker unit from the face mask via a snap/button after use, (d) cleaning the face mask using a machine or hand washing, and (e) attaching the microphone and speaker unit to the outer surface of the face mask for wearing the face mask again.

The novel face mask with integrated communication system of the present invention is particularly advantageous because the face mask ensures that the wearer can be easily heard via the microphone and the speaker, while still remaining protected against harmful airborne pathogens. Further, the wearer can easily wash the face mask after removing the speaker and microphone unit, and reattach the same after cleaning.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of the essential electronic components of one potential embodiment of the face mask with integrated communication system of the present invention in accordance with the disclosed architecture;

FIG. 2 illustrates a perspective view of one potential embodiment of the face mask with integrated communication system of the present invention in accordance with the disclosed architecture, wherein the face mask is being worn by a user;

FIG. 3 illustrates a partial perspective view of one potential embodiment of the face mask with integrated communication system of the present invention in accordance with the disclosed architecture, wherein the electronic unit has been removed from the face mask;

FIG. 4 illustrates a perspective view of one potential embodiment of the face mask with integrated communication system of the present invention in accordance with the disclosed architecture, wherein the face mask is being worn by a user without the removable electronic unit;

FIG. 5 illustrates a perspective view of one potential embodiment of the face mask with integrated communication system of the present invention in accordance with the disclosed architecture, wherein the face mask is being worn by a user with the removable electronic unit attached thereto to amplify the sound emanating from the user's speech; and

FIG. 6 illustrates a flow diagram of one potential embodiment of the method of using one potential embodiment of the face mask with integrated communication system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a protective face mask that prevents or minimizes the transmission of harmful pathogens and the spread of infectious diseases. There is also a long felt need in the art for a protective face mask with an integrated communication system that enables an individual to be easily and clearly heard by others while wearing the protective mask, and that enables a public speaker to more conveniently communicate with others while wearing the mask in a public place. Further, there is a long felt need in the art for a face mask with an integrated communication system that eliminates the need for the wearer to speak loudly, slowly and/or communicate through other actions to effectively communicate with others, and that enables teachers, trainers, presenters, professionals and others to project and/or amplify their voices. Finally, there is a long felt need in the art for a protective face mask with an integrated and removable communication system that is relatively inexpensive to manufacture, reusable, and both safe and easy to use.

The present invention, in one exemplary embodiment, is a novel personal protective face mask with a removably attached voice modulator comprising a microphone and a speaker unit. The voice modulator is specifically designed to, among other things, project the wearer's voice to his or her audience in a clear and concise manner, while also maintaining safety by permitting the wearer to speak without removing the protective face mask. The personal protective device comprises a face mask having a left curved outer surface, a right curved outer surface, a top edge and a bottom edge, wherein the outer surface is designed to fit over the wearer's mouth. Further, a snap button cap is positioned on the left curved outer surface and is designed to receive the microphone and speaker unit in a mating engagement. More specifically, the microphone and speaker unit can include a socket, wherein the snap button cap and the socket fasten together to removably attach the microphone and speaker unit to the face mask. The wearer then speaks into the microphone and is heard via a projected and/or amplified voice by listeners.

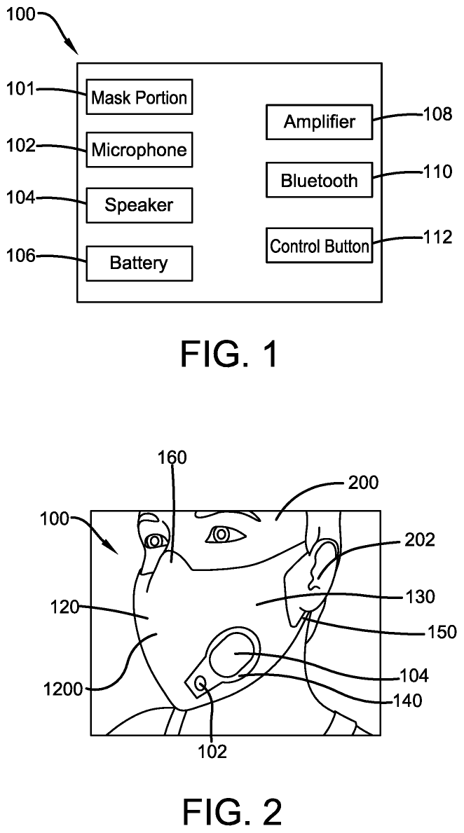

Referring initially to the drawings, FIG. 1 illustrates a diagrammatic view of the essential electronic components of one potential embodiment of the face mask with integrated communication system 100 of the present invention in accordance with the disclosed architecture. The face mask with integrated communication system 100 is comprised of a face mask portion 101, a sensitive microphone 102 to pick up sound signals uttered by a wearer of the face mask 101 and a speaker 104 to emit the sound picked up by the microphone 102. The communication system 100 can further comprise a built-in battery 106 to power all the electronic components present in the system 100, a Bluetooth module 110 to pair and connect to a portable or remote electronic device (not shown), an amplifier 108 to amplify the speaker sound, a controller or control button 112 to turn on/off the microphone 102 and/or speaker 104. The controller 112 can further be used to selectively modulate the microphone 102, speaker 104, amplifier 108 and remote electronic device. The speaker 104 and the microphone 102 can be mounted on a detachable electronic unit and retained on the exterior surface of the mask 101 via, for example, a snap or button. The speaker 104 and amplifier 108 project the voice in front of the user wearing the mask 100.

FIG. 2 illustrates a perspective view of one potential embodiment of the face mask with integrated communication system 100 of the present invention in accordance with the disclosed architecture, wherein the face mask 101 is being worn by a user. The face mask 101 has a right front surface 120, a left front surface 130 and a top edge 160 curved to fit the face of the wearer 200. Ear loops 150 are also present to engage the face mask 101 to each ear 202 of the wearer 200. Additionally, to give a proper shape to the face mask 101 while wearing the same, a longitudinal seam line 1200 is present at the approximate center of the face mask 101 which also serves to partition the right front surface 120 and the left front surface 130.

In exemplary embodiments, a snap or button is present on the left surface 130 to attach an electronic unit 140 containing the microphone 102 and the speaker 104 along with other electronic components. The positioning of the microphone 102 on the electronic unit 140 is near (i.e. proximal) to the mouth of the wearer 200 so that the microphone 102 can easily pick up the sounds uttered by the wearer 200, while at the same time subduing the breathing sound (or other non-verbal sounds) of the wearer 200.

All of the electronic components of the face mask with integrated communication system 100 of the present invention, including the microphone 102 and the speaker 104, can be comprised of relatively lightweight materials so as to enhance the comfort of the mask/system 100 as it is being worn by the wearer 200. Further, the face mask portion 101 is preferably comprised of a relatively flexible fabric material which is both machine washable and reusable. More specifically, the face mask 101 can be washed after detaching the electronic unit 140 from the attachment mechanism, i.e. snap button, placed on the left front surface 130.

One primary advantage of the face mask with integrated communication system 100 of the present invention is that the electronic unit 140 is easily detachable from the face mask portion 101, so that the face mask 101 can be used as a conventional face mask 101 when the communication system is not required, such as when a user is travelling, sleeping or not speaking. Additionally, as previously stated, the face mask 101 can be easily washed without worry of causing damage to the electronic unit 140. In one embodiment, the electronic components can be accessed by unscrewing the top body of the electronic unit 140. The face mask 101 can also be used with electronic units 140 of different colors to give an attractive aesthetic appearance to the face mask system 100. In one embodiment of the present invention, an elastic band can be used in place of the ear loops 150 to secure the mask system 100 to the face of the wearer 200. Further, the microphone 102 may comprise a relatively thin and lightweight noise-cancelling microphone.

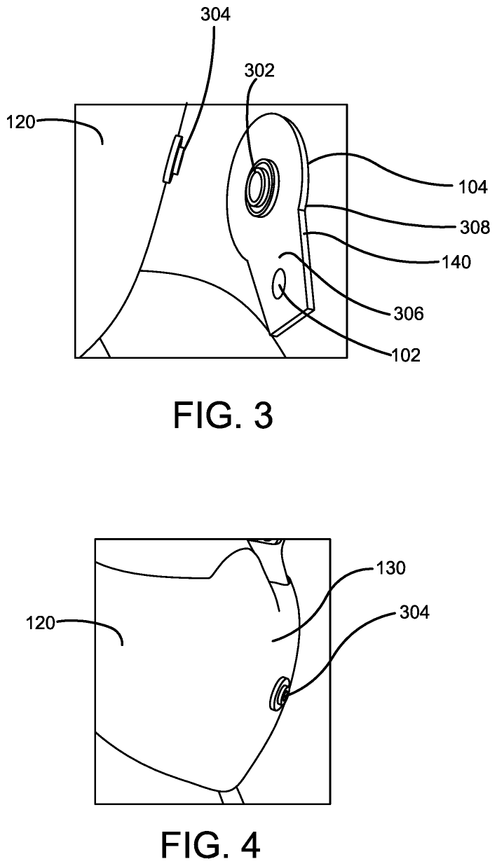

FIG. 3 illustrates a partial perspective view of one potential embodiment of the face mask with integrated communication system 100 of the present invention in accordance with the disclosed architecture, wherein the electronic unit 140 has been removed from the face mask portion 101. More specifically, the electronic unit 140 that is comprised of the speaker 104 and the microphone 102 can be easily detached from the face mask portion 101 by detaching the socket 302 of the electronic unit 140 from the cap 304 present on the left surface 120 (or, in other embodiments, the right surface 120) of the face mask portion 101. It should be appreciated that any type of lightweight and machine washable fastener, such as a magnetic fastener or hook and loop fastener, can also be used to attach and detach the microphone 102 and the speaker 104 to the face mask portion 101. The cap 304 can be permanently sewn to the face mask 100. Without the attached speaker 104 and the microphone 102, the face mask 101 can be used as a conventional face mask.

In one embodiment, the speaker 104 is generally circular in shape and may be positioned on the outer surface 308 of the electronic unit 140 so that there is no interference with the sounds emanating therefrom. The microphone 102 is preferably positioned on the inner surface 306 near the bottom of the electronic unit 140, so as to be closer to the mouth of the wearer 200. Other electronic components such as the battery 106 (disposable or rechargeable), amplifier 108 and Bluetooth module 110 can also be present within the electronic unit 140.

FIG. 4 illustrates a perspective view of one potential embodiment of the face mask with integrated communication system 100 of the present invention in accordance with the disclosed architecture, wherein the face mask system 100 is being worn by a user 200 without the removable electronic unit 140. More specifically, the cap 304 of the fastening mechanism, in one exemplary embodiment, is permanently sewn to the left front outer surface 130. The cap 304 is sewn only to the outer surface, such that the cap 304 is not in contact with the skin of the wearer 200, as it may cause irritation thereto. Alternatively, the cap 304 can be fixed using a permanent adhesive that is machine washable. The placement of the cap, in another embodiment, can be on the right front surface 120 as per the needs and/or requirements of the user 200. Depending on the size of the particular face mask 100, the placement of the cap 304 should be such that it generally aligns with the cheek of the wearer 200, and the attached microphone 102 is positioned just below the lips and above the chin of the wearer 200. Similarly, it should also be appreciated that the shape of the right front surface 120 and the left front surface 130, along with the shape of the ear loops 150 (or similar retention mechanisms), can be customized based on different designs while maintaining the efficiency of the electronic unit 140 including, without limitation, the microphone 102 and the speaker 104 and protecting the wearer 200 from airborne pathogens, harmful particulates and the like.

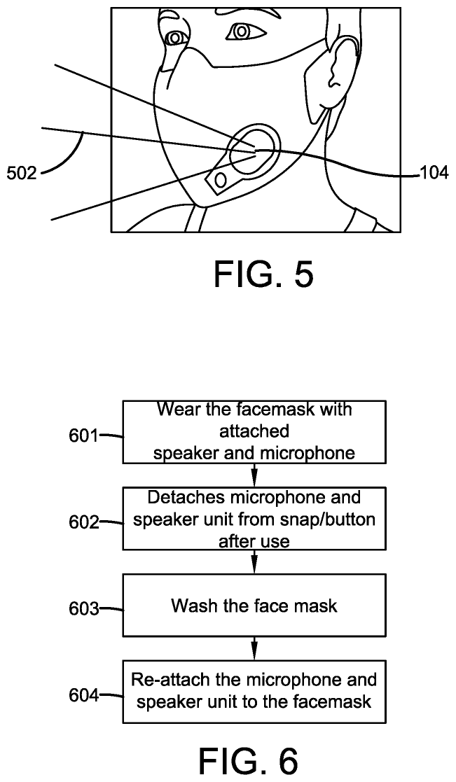

FIG. 5 illustrates a perspective view of one potential embodiment of the face mask with integrated communication system 100 of the present invention in accordance with the disclosed architecture, wherein the face mask 101 is being worn by a user with the removable electronic unit 140 attached thereto to amplify the sound emanating from the user's speech. More specifically, the speaker 104 receives the sound from the microphone 102 and the same is amplified through the amplifier 108. The speaker 104 also projects the sound 502 in the direction in front of and to the sides of the user 200, and the projected sound 502 has a higher power and travels a greater distance than it otherwise would without the presence of the electronic unit 140. The power of sound (in dB) is amplified when emitted from the speaker 104, and the volume of the speaker 104 can be controlled (i.e. increased or decreased) using the control button 112.

Alternatively, the sound 502 from the speaker 104 can be controlled using a mobile software application that can be downloaded onto an electronic device (not shown), such as a smartphone, that can be used in conjunction with the face mask system 100 of the present invention. The projected sound 502 from the speaker 104, using the amplifier 108 and controller 112, enables users such as teachers, presenters, or any other individuals to project and modulate their voice while maintaining safety by wearing the protective face mask 100. The control button 112 can also control the operation of the microphone 102.

FIG. 6 illustrates a flow diagram of one potential embodiment of the method of using one potential embodiment of the face mask with integrated communication system 100 of the present invention in accordance with the disclosed architecture. At step 601, the user 200 puts on the face mask with integrated communication system 100 of the present invention to protect himself/herself and members of the audience while communicating with the same in a clear and concise manner and without having to strain his or her voice. After the use is complete (i.e., a single use or multiple uses), at step 602, the user 200 may easily detach the electronic unit 140 from the face mask portion 100 as described herein and to enable the user 200 to wash the face mask portion 101 at step 603, or simply use the face mask portion 101 as a conventional face mask. Once the face mask portion 101 without the electronic unit 140, namely the microphone 102 and speaker 104, is cleaned using a machine or hand wash at step 603, the electronic unit 140 may be easily reattached to the face mask portion 101 in the manner described herein, and the face mask with integrated communication system 100 may be returned to productive use.

In this manner, the face mask with integrated communication system 100 is reusable and can be easily carried in a pocket of the user 200. Additionally, the microphone 102 and the speaker 104 can be separated from the electronic unit 140 as well for easy portability and/or if one of the same becomes damaged or needs replaced. It should also be appreciated that the microphone 102 enables the wearer 200 of the face mask system 100 to speak to a paired and connected electronic device, i.e. remote speaker, through a wireless communication channel without physically connecting thereto. The face mask system 100 can also be used with an electronic device having a voice command feature, and may further comprise one or more logos, customized designs, personalized names or the like printed on its outer surface, to enhance the appearance of the face mask system 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “face mask system”, “system”, “protective face mask system”, “voice modulator” and “microphone and speaker equipped face mask” are interchangeable and refer to the face mask with integrated communication system 100 of the present invention.

Notwithstanding the forgoing, the face mask with integrated communication system 100 of the present invention and its various components can be of any suitable size and configuration as is known in the art without affecting the overall concept of the invention, provided that they accomplish the above-stated objectives. One of ordinary skill in the art will appreciate that the size, configuration and material of the face mask with integrated communication system 100 and its various components as shown in the FIGS. are for illustrative purposes only, and that many other sizes and shapes of the face mask with integrated communication system 100 are well within the scope of the present disclosure. Although the dimensions of the face mask with integrated communication system 100 and its various components are important design parameters for user convenience, the face mask with integrated communication system 100 and its various components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective mask configured to provide a protective barrier to a face of a user, the protective mask comprising:
a mask portion having an outer surface;
a voice modulator for modulating a voice of the user, wherein the voice modulator comprises a microphone and a speaker; and
an attachment mechanism for selective removal of said voice modulator from said mask portion.

2. The protective mask of claim 1, wherein said voice modulator further comprises an amplifier for amplifying the voice of said user.

3. The protective mask of claim 2, wherein said voice modulator further comprises a controller for selectively modulating at least one of said microphone, said speaker and said amplifier.

4. The protective mask of claim 3, wherein said voice modulator further comprises a Bluetooth module for wireless connection to a remove device.

5. The protective mask of claim 4, wherein said voice modulator further comprises a battery for powering said voice modulator.

6. The protective mask of claim 1, wherein said mask portion is washable after selective removal of said voice modulator from said mask portion.

7. The protective mask of claim 1, wherein said attachment mechanism is selected from a group consisting of a snap, a button, a magnet and a hook and loop fastener.

8. A protective mask configured to provide a protective barrier to a face, the protective mask comprising:
an outer surface for mounting of a voice modulator thereto for modulating a voice of a user;
said voice modulator comprising a microphone, a speaker and an amplifier; and
said voice modulator further comprising a controller for selectively modulating at least one of said microphone, said speaker and said amplifier.

9. The protective mask of claim 8, wherein said voice modulator further comprises an attachment mechanism for selective removal of said modulator from said outer surface.

10. The protective mask of claim 8, wherein said voice modulator further comprises a Bluetooth module for wireless connection to a remove device.

11. The protective mask of claim 8, wherein said voice modulator further comprises a battery for powering said voice modulator.

12. The protective mask of claim 8, wherein the protective mask is washable after selective removal of said voice modulator from said outer surface.

13. The protective mask of claim 9, wherein said attachment mechanism is selected from a group consisting of a snap, a button, a magnet and a hook and loop fastener.

14. A method of modulating a voice of a user wearing a protective mask, said method comprising:
providing said protective mask with a voice modulator including a microphone, a speaker, an amplifier and a controller;
securing the protective mask over a mouth and a nose of the user; and
adjusting said controller to selectively modulate at least one of said microphone, said speaker and said amplifier.

15. The method of claim 14, further comprising removing said voice modulator from said protective mask and washing said protective mask.

16. The method of claim 14, wherein said voice modulator further comprises an attachment mechanism for selectively removing said voice modulator from said protective mask.

17. The method of claim 16, wherein said voice modulator further comprises a Bluetooth module for wireless connection to a remove device.

18. The method of claim 17, wherein said voice modulator further comprises a battery for powering said voice modulator.

19. The method of claim 16, wherein said attachment mechanism is selected from a group consisting of a snap, a button, a magnet and a hook and loop fastener.

20. The method of claim 18, wherein said battery is rechargeable.
